(19) United States
(12) Patent Application Publication
(10) Pub. No.: US 2015/0024179 A1
(43) Pub. Date: Jan. 22, 2015

(54) MANUFACTURING METHOD AND STRUCTURE OF HAVING A PORCELAIN OR GLASS PRODUCT FORMED INTEGRALLY WITH A LABEL IN A MOLD

(71) Applicants: SHENG-CHANG HUANG, Kaohsiung City (TW); SUPREME TECHNIC PACKAGE CO., LTD, Kaohsiung City (TW)

(72) Inventor: SHENG-CHANG HUANG, KAOHSIUNG CITY (TW)

(73) Assignees: SUPREME TECHNIC PACKAGE CO., LTD, Kaohsiung City (TW); SHENG-CHANG HUANG, Kaohsiung City (TW)

(21) Appl. No.: 13/946,993

(22) Filed: Jul. 19, 2013

(51) Int. Cl. B29C 31/00

(52) U.S. Cl. CPC B29C 31/008
USPC 428/210; 264/279; 428/446; 428/426

(57) ABSTRACT

A manufacturing method and structure of having a porcelain or glass product formed integrally with a label in a mold includes a male mold, a first female mold and a second female mold. After the first female mold is combined with the male mold, plastics is injected to form a soft mold sleeve on the male mold and then a porcelain or glass product is fitted on the soft mold sleeve. After the second female mold is combined with the male mold, plastics is injected to form a plastic layer on the outer surface of the product and then, a radio frequency identification chip is provided between the product and the plastic layer or a label is positioned in the mold cavity of the second female mold, which is combined with the male mold. Then plastic is injected to form a plastic layer covered on the surface of the product and combined with the label integrally.

### BACKGROUND OF THE INVENTION

1. Field of the Invention

This invention relates to a manufacturing method of having a porcelain or glass product formed integrally with a label in a mold, particularly to one having a male mold, a first female mold and a second female mold operated mutually and having a shaping machine in advance injecting or extruding plastics to cover a predetermined range of the male mold to make up a soft mold sleeve on the surface of the male mold seat. Then, a porcelain or glass product is closely fitted on the soft mold sleeve combined at the outer side of the male mold, and the shaping machine once more injects or extrudes plastics into a molding groove formed between the second female mold and the male mold. At this time, a plastic layer can be provided on the whole or on a part of the outer surface of the porcelain or glass product, or a radio frequency identification chip can be installed between the porcelain or glass product and the plastic layer, or a label can be attached to the whole or a part of the external surface of the plastic layer, or a radio frequency identification chip is installed between the porcelain or glass product and the plastic layer. Thus, a label can be formed integrally with a porcelain or glass product in a mold.

A structure of having a porcelain or glass product formed integrally with a label with in a mold is to have the plastic layer provided on the whole or on a part of the outer surface of a porcelain or glass product, or have a radio frequency identification chip installed between the porcelain or glass product and the plastic layer, or have a label stuck to the whole or a part of the outer surface of the plastic layer at the outer side of the porcelain or glass product, or have the radio frequency identification chip set between the porcelain or glass product and the whole or a part of the outer surface of the plastic layer, thus finishing having a porcelain or glass product formed integrally with a label in a mold.

2. Description of the Prior Art

Generally, temperature of shaping porcelain or glass products is extremely high, over 800° C. and hence, ink printed labels are impossible to be combined with the porcelain or glass products when they are being shaped. Therefore, commercially available porcelain or glass products used as containers or utensils must have labels attached thereon for indicating the contents in the containers, and all the labels are attached on the porcelain or on glass products in a mode of gluing. As a result, intentional lawbreakers have loopholes to exploit, so long as they collect used porcelain or glass products and paste labels thereon anew, they can attain the purpose of counterfeiting labels. Thus, counterfeits with flaws and poor quality are apt to be confounded and circulated in the markets, but common consumers cannot discriminate counterfeit products from genuine products, thus directly affecting consumers' rights and interests and even endangering consumers' health if the contents are food and drink.

For this reason, having been devoted to manufacturing and design technique related to injection and extrusion technique for many years, the inventor of this invention has paid much attention to various fragile articles like porcelain or glass products and researches into the problem in technique how to have a radio frequency identification chip installed in a plastic layer or have a label formed integrally with a porcelain or glass product, thus devising this invention.

### SUMMARY OF THE INVENTION

A first objective of this invention is to offer a manufacturing method of having a porcelain or glass product provided thereon with a plastic layer that can be used for protecting fragile porcelain or glass products, or can serve as a holding layer or a heat-insulating layer, or/and can be provided thereon with a radio frequency identification chip to offer a source identification and authentication of the porcelain or glass product.

A second objective of this invention is offer a porcelain or glass product that is formed integrally with a label, or/and installed with a radio frequency identification chip. Thus, after such porcelain or glass products are used, it is impossible to recover the original condition of the external labels of the porcelain or glass products; therefore, intentional law breakers are unable to collect such used porcelain or glass products to be filled therein with poor-quality contents for deceiving consumers, able to completely prevent poor-quality products that are counterfeited or imitated.

A manufacturing method of having a porcelain or glass product formed integrally with a label in a mold in the present invention includes a shaping mold consisting of a male mold, a first female mold and a second female mold. After the first female mold is combined with the male mold, plastics is injected or extruded by a shaping machine to cover a predetermined range of the male mold to form a soft mold sleeve at the predetermined range of the male mold. Subsequently, a porcelain or glass product shaped in advance is fitted around the soft mold sleeve at the outer side of the male mold, and after the second female mold is combined with the male mold, plastic is injected or extruded into a molding groove formed between the second female mold and the male mold to have the whole or a part of the outer surface of the porcelain or glass product provided with a plastic layer to finish manufacturing a plastic layer attached to a porcelain or glass product. Or, a radio frequency identification chip can be beforehand stuck to a porcelain or glass product and, after the second female mold is combined with the male mold, plastic is injected or extruded in the molding groove formed between the second female mold and the male mold to have the outer side of the porcelain or glass product provided with a plastic layer to complete manufacturing of having a porcelain or glass product formed integrally with a radio frequency identification chip and plastic layer.

Another manufacturing method of having a porcelain or glass product formed integrally with a label in a mold in the present invention is to have the first female mold combined with the male mold and then, have a shaping machine injecting or extruding plastic to cover a predetermined range of the male mold to form a soft mold sleeve at the predetermined range of the male mold. Afterward, a porcelain or glass product shaped beforehand is fitted around the outer side of the soft mold sleeve outside the male mold, and a label is deposited in the mold cavity of the second female mold. Then, the second female mold is combined with the male mold and plastic is injected or extruded into a molding groove formed between the second female mold and the male mold to have the whole or a part of the outer surface of the porcelain or glass product provided with a plastic layer and have the whole or a part of the outer surface of the plastic layer provided with the label to finish having a porcelain or glass product formed integrally with a label in a mold. Or, a radio frequency identification chip is in advance stuck to a porcelain or glass product and, after the second female mold is combined with the male mold, plastic is injected or extruded into a molding groove formed between the second female mold and the male mold to have the porcelain or glass product provided with the radio frequency identification chip and have the whole or a part of the outer surface of the porcelain or glass product provided with a plastic layer and then, a label is provided at the whole or a part of the outer surface of the plastic layer to finish manufacturing of having a porcelain or glass product formed integrally with a radio frequency identification chip and a label in a mold.

A structure of a porcelain or glass product formed integrally with a label in a mold in the present invention is to have the whole or a part of the outer surface of a porcelain or glass product provided with a plastic layer to serve as a protective layer, a heat-insulating layer or a holding layer of the porcelain or glass product, or have a radio frequency identification chip provided between a porcelain or glass product and a plastic layer to offer source authentication and identification of the porcelain or glass product.

Another structure of a porcelain or glass product formed integrally with a label in a mold in the present invention is to have the whole or a part of the outer surface of a porcelain or glass product provided with a plastic layer and have an outer side of the plastic layer provided with a label, thus, able to have a porcelain or glass product formed integrally with a label in a mold. Or, a radio frequency identification chip is provided between the porcelain or glass product and a plastic layer and a label is provided at the whole or a part of the outer surface of the plastic layer, thus able to have a porcelain or glass product formed integrally with a label in a mold.

### BRIEF DESCRIPTION OF DRAWINGS

This invention will be better understood by referring to the accompanying drawings, wherein:

FIG. 1 is a flow chart of a first preferred embodiment of a manufacturing method of having a porcelain or glass product formed integrally with a label in a mold in the present invention;

FIG. 2 is a schematic view of a male mold corresponding to a first female mold in the present invention;

FIG. 3 is a schematic view of the male mold combined with the first female mold and injected or extruded therein with plastics in the present invention;

FIG. 4 is a schematic view of a first preferred embodiment of having the surface of the male mold formed with a soft mold sleeve in the present invention;

FIG. 4A is a bottom view of FIG. 4;

FIG. 4B is a bottom view of a second preferred embodiment of the male mold and the soft mold sleeve in the present invention;

FIG. 4C is a bottom view of a third preferred embodiment of the male mold and the soft mold sleeve in the present invention;

FIG. 4D is a bottom view of a fourth preferred embodiment of the male mold and the soft mold sleeve in the present invention;

FIG. 4E is a side view of a fifth preferred embodiment of the male mold and the soft mold sleeve in the present invention;

FIG. 5 is schematic view of the first preferred embodiment of the manufacturing method of having a porcelain or glass product formed integrally with a label in a mold in the present invention, illustrating that the male mole corresponds with a second female mold before a porcelain or glass product is fitted on the male mold;

FIG. 6A a schematic view of the first preferred embodiment of the manufacturing method in the present invention, illustrating that a porcelain or glass product is fitted on the male mold, and plastic material is injected or extruded after the male mold is combined with the second female mold;

FIG. 6B is a cross-sectional view of a first preferred embodiment of a product structure corresponding to FIG. 6A;

FIG. 7 is a flow chart of a second preferred embodiment of a manufacturing method of having a porcelain or glass product formed integrally with a label in a mold in the present invention;

FIG. 8 is a schematic view of the second preferred embodiment of the manufacturing method of having a porcelain or glass product formed integrally with a label in a mold in the present invention, illustrating a corresponding condition of a male mold and a second female mold before the male mold is fitted with a porcelain or glass product;

FIG. 9A is a schematic view of the second preferred embodiment of the manufacturing method in the present invention, illustrating that the male mold is fitted thereon with a porcelain or a glass product and combined with a second female mold for injecting or extruding therein with plastics;

FIG. 9B is a cross-sectional view of a second preferred embodiment of a product structure corresponding to FIG. 9A;

FIG. 10 is a flow chart of a third preferred embodiment of a manufacturing method of having a porcelain or glass product formed integrally with a label in a mold in the present invention;

FIG. 11 is a schematic view of the third preferred embodiment of the manufacturing method in the present invention, illustrating a corresponding condition of a male mold and a second female mold before the male mold is fitted thereon with a porcelain or glass product;

FIG. 12A is a schematic view of the third preferred embodiment of the manufacturing method in the present invention, illustrating that the male mold is fitted thereon with a porcelain or glass product and combined with the second female mold for injecting or extruding therein with plastics;

FIG. 12B is a cross-sectional view of a third preferred embodiment of a product structure corresponding to FIG. 12A;

FIG. 13 is a flow chart of a fourth preferred embodiment of a manufacturing method of having a porcelain or glass product formed integrally a label in a mold in the present invention;

FIG. 14 is a schematic view of the fourth preferred embodiment of the manufacturing method in the present invention, illustrating a corresponding state of a male mold and a second female mold before the male mold is fitted thereon with a porcelain or a glass product;

FIG. 15A is a schematic view of the fourth preferred embodiment of the manufacturing method in the present invention, illustrating that the male mold is fitted thereon with a porcelain or glass product and combined with the second female mold for injecting or extruding therein with plastics;

FIG. 15B is a cross-sectional view of a fourth preferred embodiment of a product structure corresponding to FIG. 15A;

FIG. 16A is a schematic view of a fifth preferred embodiment of the manufacturing method in the present invention, which is applicable to the preferred embodiments 1-4 is a case that a male mold is fitted thereon with a porcelain or glass product and combined with the second female mold to be injected or extruded therein with plastics;

FIG. 16B is a cross-sectional view of the fifth preferred embodiment of a product structure corresponding to FIG. 16A;

FIG. 17A is a schematic view of a sixth preferred embodiment of the manufacturing method in the present invention, which is applicable to the preferred embodiments 1-4 in a case that a male mold is fitted thereon with a porcelain or glass product and combined with the second female mold to be injected or extruded therein with plastics;

FIG. 17B is a cross-sectional view of the sixth preferred embodiment of a product structure corresponding to FIG. 17A;

FIG. 18 is a schematic view of a seventh preferred embodiment of the manufacturing method in the present invention, which can be applied to the preferred embodiments 1-4 in a case that a male mold is fitted thereon with a porcelain or glass product and combined with the second female mold for injecting or extruding plastics therein;

FIG. 19A is a front view of the seventh preferred embodiment of a product structure corresponding to FIG. 18;

FIG. 19B is a front view of an eighth preferred embodiment of the product structure corresponding to FIG. 18;

FIG. 19C is a front view of a ninth preferred embodiment of the product structure corresponding to FIG. 18;

FIG. 19D is a front view of a tenth preferred embodiment of the product structure corresponding to FIG. 18; and

FIG. 19E is a front view of an eleventh preferred embodiment of the product structure corresponding to FIG. 18.

### DETAILED DESCRIPTION OF THE PREFERRED EMBODIMENT

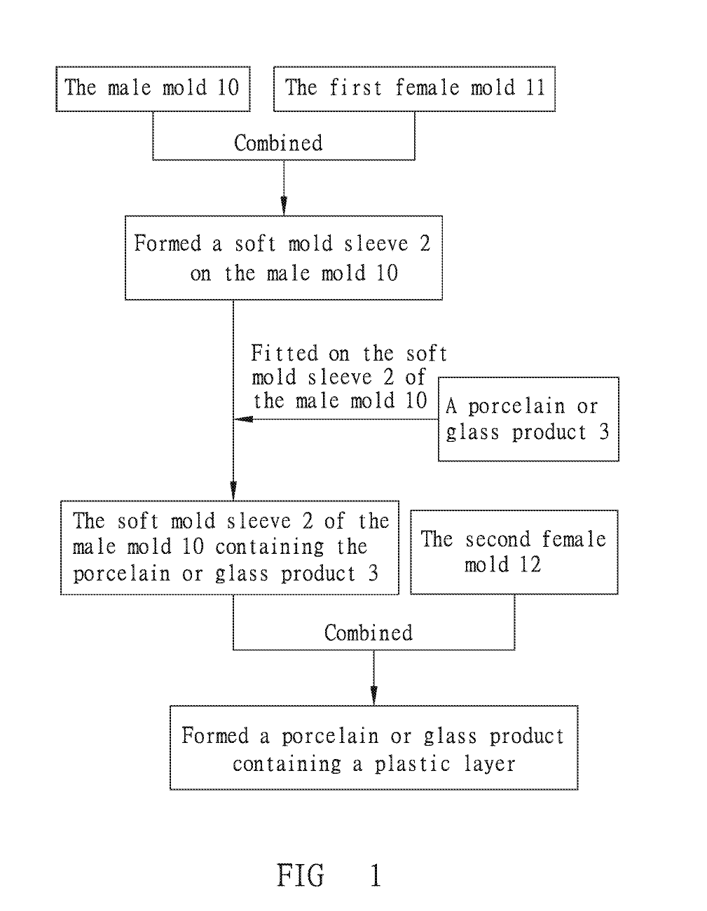

A first preferred embodiment of a manufacturing method and structure of having a porcelain or glass product formed integrally with a label in a mold in the present invention is shown in FIGS. 1-6.

The manufacturing method of having a porcelain or glass product formed integrally with a label in a mold in the present invention, as shown in FIG. 1, includes a shaping mold 1 consisting of a male mold 10, a first female mold 11 and a second female mold 12. After the first female mold 11 and the male mold 10 are combined together, a plastic injection shaping machine or a plastic extrusion shaping machine (not shown) is operated to inject or extrude plastics to cover a predetermined range of the male mold 10, which can be the whole or a part of the outer surface of the male mold 10, or which can be a circumferential side or a bottom side, and thus, a soft mold sleeve 2 can be fitted on the predetermined range of the male mold 10. Subsequently, a porcelain or glass product 3 shaped beforehand is fitted on the outer side of the soft mold sleeve 2 fitted on the male mold 10 and then, the second female mold 12 is combined with the male mold 10 and the plastic injection shaping machine or the plastic extrusion shaping machine is once more operated to inject or extrude plastics into a molding groove formed between the second female mold 12 and the soft mold sleeve 2 fitted on the male mold 10, letting the whole or a part of the outer surface of the porcelain or glass product form a plastic layer 4. Foresaid plastic layer 4 made of foamed plastic is optimal, which can serve as a protective layer, a heat-insulating layer, a heat-preserving layer or a holding layer of a porcelain or glass product. Thus, a porcelain or glass product can be formed integrally with a plastic layer in a mold.

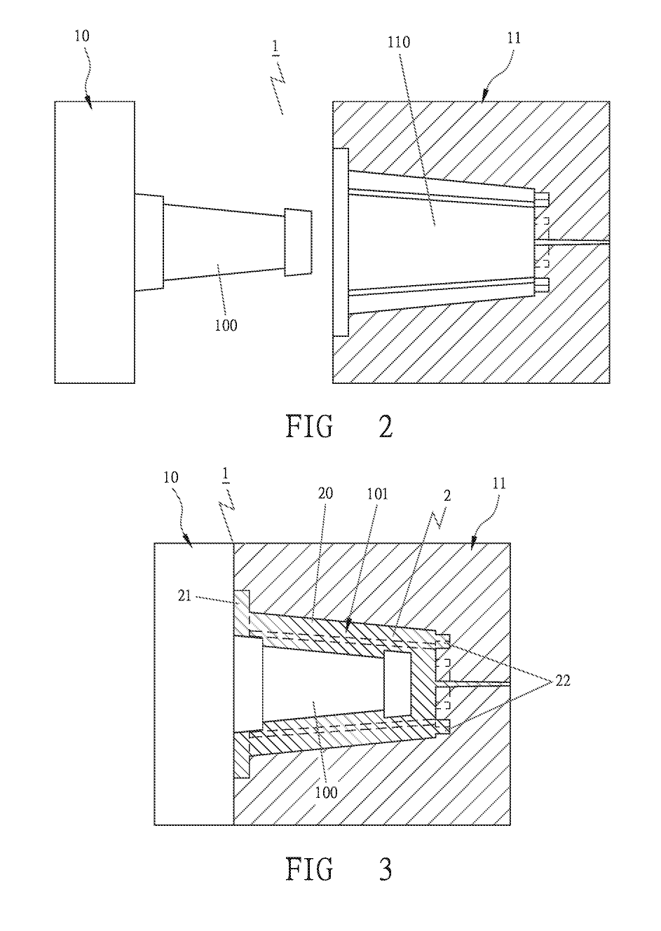

FIG. 2 shows the male mold 10 and the first female mold 11 of the first preferred embodiment. The male mold 10 is formed with a proper recessed circumference 100 for enabling the soft mold sleeve 2 to be tightly combined with the male mold 10 not to fall off. The first female mold 11 is provided with a mold cavity 110 that is formed according to the outward shape of the soft mold sleeve 2.

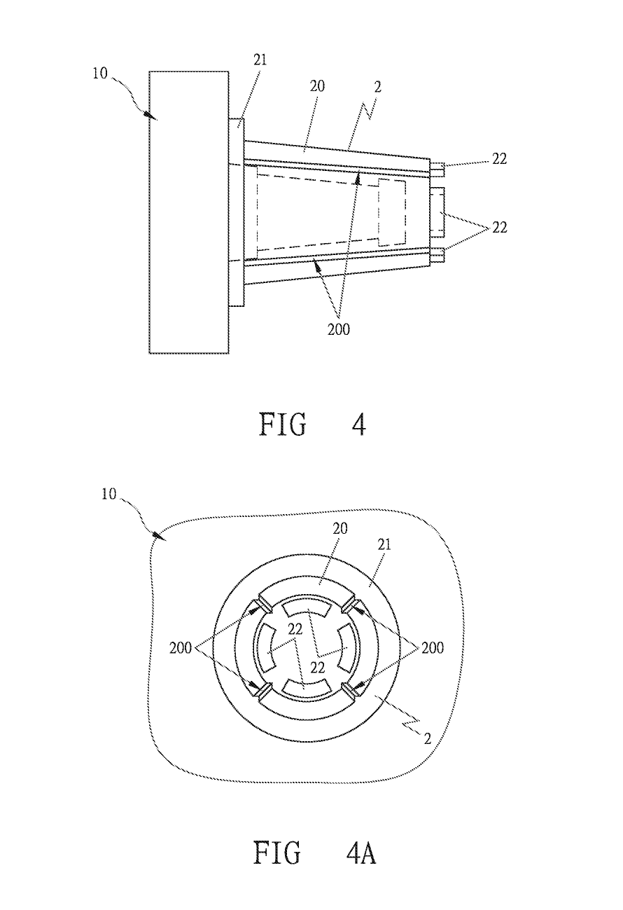

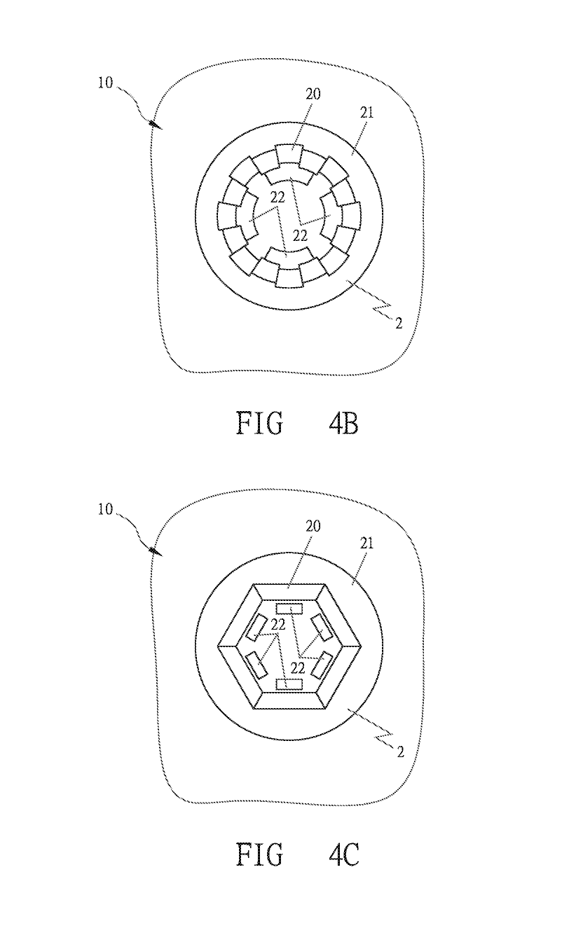

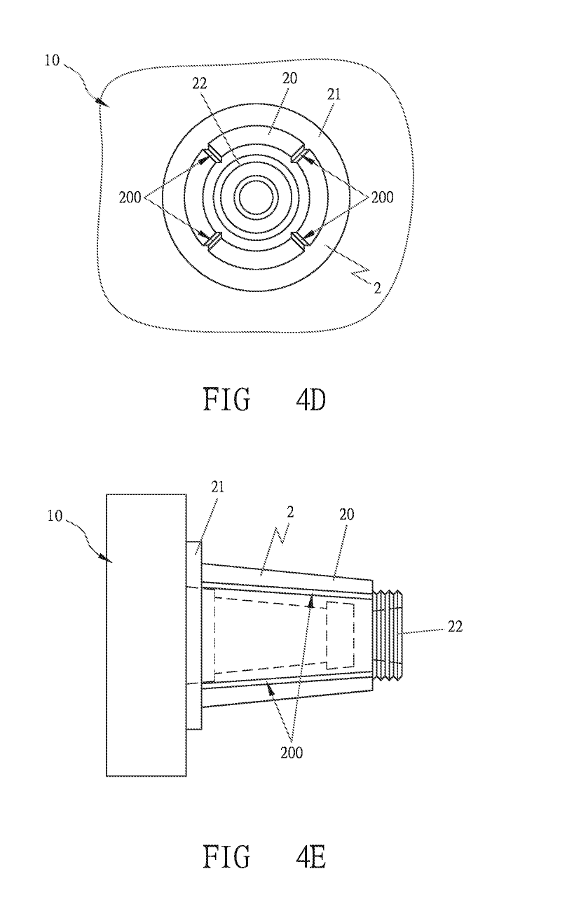

Referring to FIG. 3, after the first female mold 11 and the male mold 10 are combined together, the plastic injection shaping machine or the plastic extrusion shaping machine is operated to inject or extrude plastics into the molding groove 101 formed between the male mold 10 and the first female mold 11 and after the male mold 10 and the first female mold 11 are separated, the predetermined range of the male mold 10 can be sheathed by a soft mold sleeve 2, as shown in FIG. 4. And foresaid soft mold sleeve 2 can be used repeatedly until it is broken and falls off the male mold 10. To replace the soft mold sleeve 2 with a new one, only have the male mold 10 and the first female mold 11 combined together again and as previously stated, have a shaping machine injecting or extruding plastics into the molding groove 101 formed between the male mold 10 and the first female mold 11. Thus, a new soft mold sleeve 2 can be once more provided at a predetermined range of the male mold 10 after the male mold 10 is separated from the first female mold 11.

Referring to FIGS. 4 and 4A, the soft mold sleeve 2 is formed with a circumferential surface 20 having its outer side disposed with a plurality of recesses 200 for preventing the soft mold sleeve 2 and the inner wall of a porcelain or glass product 3 from being stuck closely to enable the porcelain or glass product 3 to be timely removed from the soft mold sleeve 2. Further, the circumferential surface 20 has one side formed with a large ring surface 21 for the porcelain or glass product 3 to resist thereon and for restricting the combination state of the porcelain or glass product 3 with the soft mold sleeve 2. The circumferential surface 20 has another side provided with protruding member(s) 22, which can be plural or single, as shown in FIG. 4E, and the protruding members 22 can produce a proper compression effect after being pressed. The compressible protruding members 22 are provided for resisting the inner bottom side of the porcelain or glass product 3 to prevent the porcelain or glass product 3 from being pressed and broken when the second female mold 12 is combined with the male mold 10.

Actually, the soft mold sleeve 2 can be made into any shape, such as a polygonal cone, as shown in FIG. 4B, or staggered double-diameter cone, as shown in FIG. 4C. The foresaid protruding member 22 can be annular shape, as shown in FIG. 4D, or a wavy annular shape in outer surface, as shown in FIG. 4E, that is, the soft mold sleeve 2 of this invention is not restricted in shape that is applicable, and preferably, the soft mold sleeve 2 can match with the shape of the inner wall 31 of a porcelain or glass product 3. The protruding members 22 are also unlimited in shape so long as the protruding members 22 can resist the inner bottom side of a porcelain or glass product 3 and can absorb a part of pressing force when the second female mold 12 is combined with the male mold 10 for preventing the porcelain or glass product 3 from being broken.

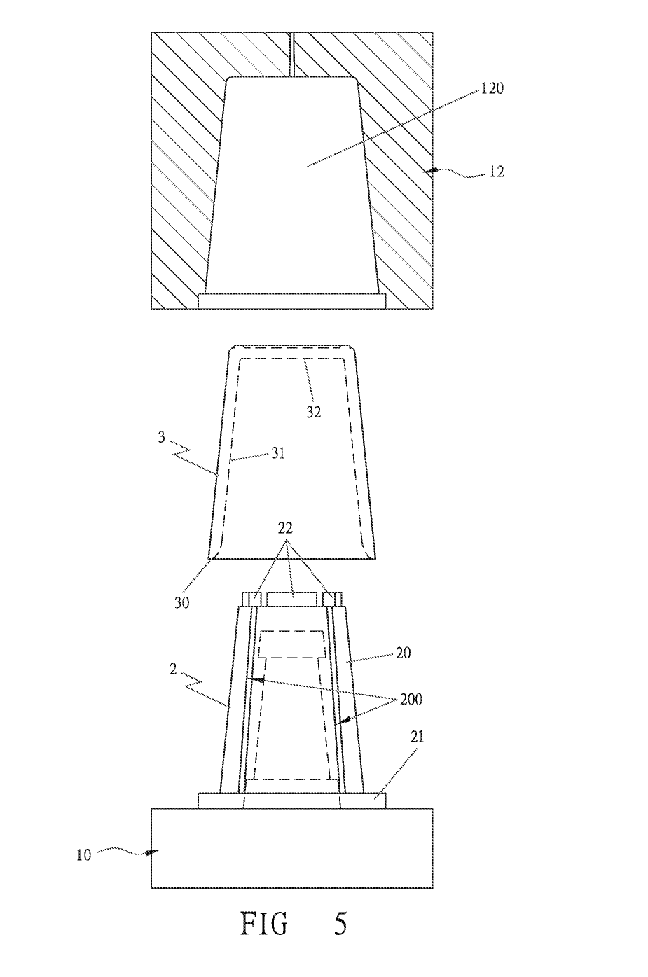

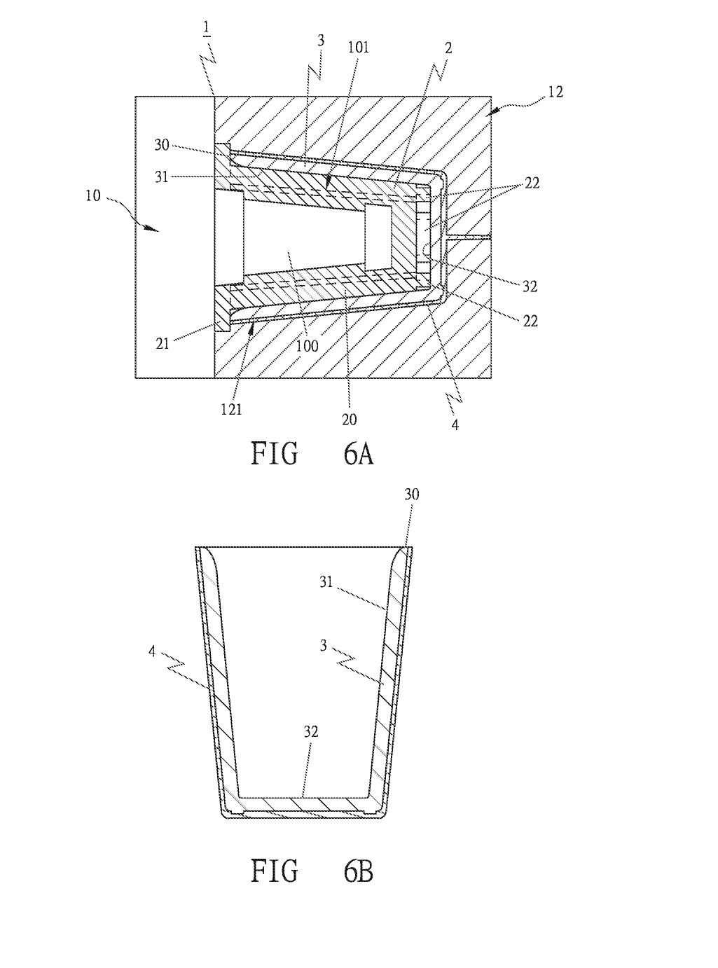

Referring to FIGS. 5 and 6A, when a porcelain or glass product 3 is to be formed integrally with a plastic layer 4, the porcelain or glass product 3 has to be first fitted on the soft mold sleeve 2 of the male mold 10. At this time, the front end 30, the inner wall 31 and the bottom side 32 of the porcelain or glass product 3 will respectively resist against the large ring surface 21, the circumferential surface 20 and the protruding members 22 of the soft mold sleeve 2, as shown in FIG. 6A, Thus, the porcelain or glass product 3 can be completely fixed on the outer side of the male mold 10 and impossible to fall off via elastic expansion characteristics of the soft mold sleeve 2. Afterward, the male mold 10 is received in the mold cavity 120 of the second female mold 12 to form a molding groove 121 between the second female mold 12 and the porcelain or glass product 3 and meanwhile, the shaping machine is operated to inject or extrude plastics into the molding groove 121, able to have the whole or a part of the outer surface of the porcelain or glass product 3 formed with a plastic layer 4 and thus finishing having a porcelain or glass product 3 formed integrally with a plastic layer 4 in a mold.

FIG. 6B shows the structure of the product produced through the manufacturing method of the first preferred embodiment. The porcelain or glass product 3 has the whole or a part of the outer surface forming the plastic layer 4 made from various kinds of proper plastic materials, and it is most ideal to make the plastic layer 4 from foamed plastics to form proper soft and hard elasticity to serve as a protective layer, a heat-insulating layer, a heat-preserving layer or a grasping layer of the porcelain or glass product 3.

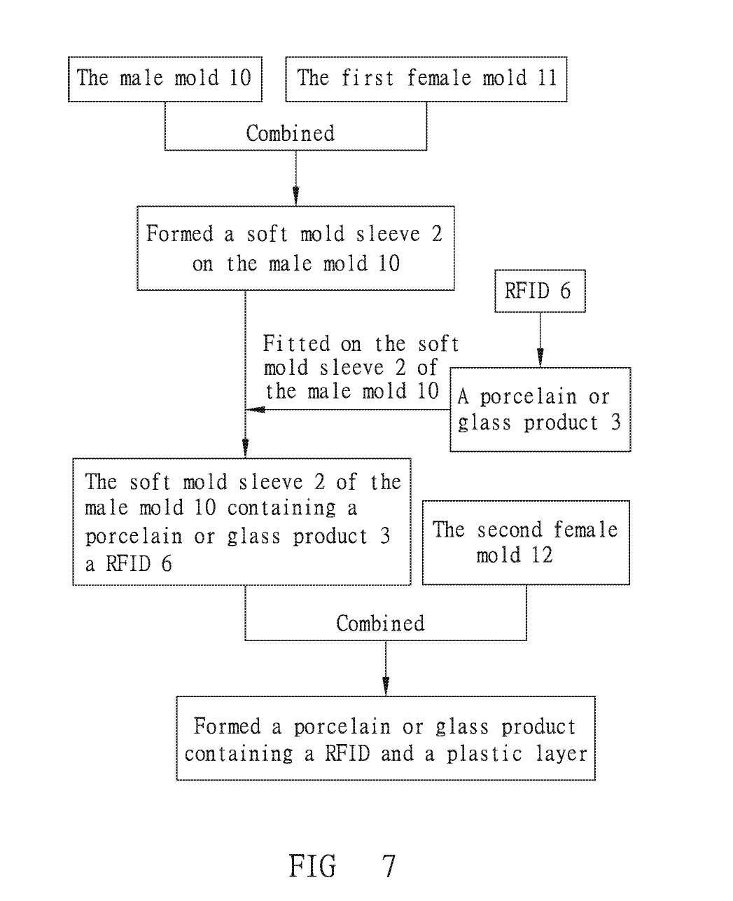

A second preferred embodiment of a manufacturing method and structure of having a porcelain or glass product formed integrally with a label in a mold in the present invention, as shown in FIG. 7, is derived from and has technical correlation with the manufacturing method of the first preferred embodiment. In this preferred embodiment, a shaping mold 1 consists of a male mold 10, a first female mold 11 and a second female mold 12. After the first female mold 11 is combined with the male mold 10, a shaping machine is operated to inject or extrude plastics to cover a predetermined range of the male mold 10, which can be the whole or a part of the outer surface of the male mold 10, or the annular side or the bottom side of the male mold 10. Thus, the male mold 10 has a predetermined range fitted thereon with a soft mold sleeve 2. Subsequently, a porcelain or glass product 3 shaped in advance is installed with a radio frequency identification chip (RFID) 6 at a proper location and then the porcelain or glass product 3 is fitted around the outer side of the soft mold sleeve 2 of the male mold 10. Next, the second female mold 12 is combined with the male mold 10 and then, a plastic injection shaping machine or a plastic extrusion shaping machine is operated to inject or extrude plastics into a molding groove formed between the second female mold 12 and the male mold 10 to have the whole or a part of the outer surface of the porcelain or glass product 3 covered up with a plastic layer 4, with the radio frequency identification chip (RFID) 6 positioned between the porcelain or glass product 3 and the plastic layer 4, thus finishing having a porcelain or glass product 3 formed integrally with a radio frequency identification chip (RFID) 6 and a plastic layer 4 in a mold.

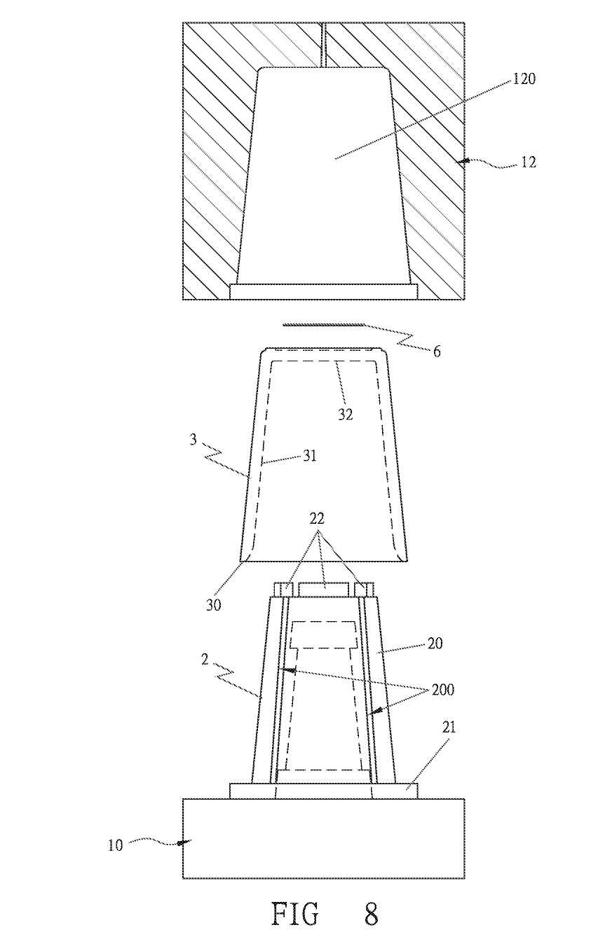

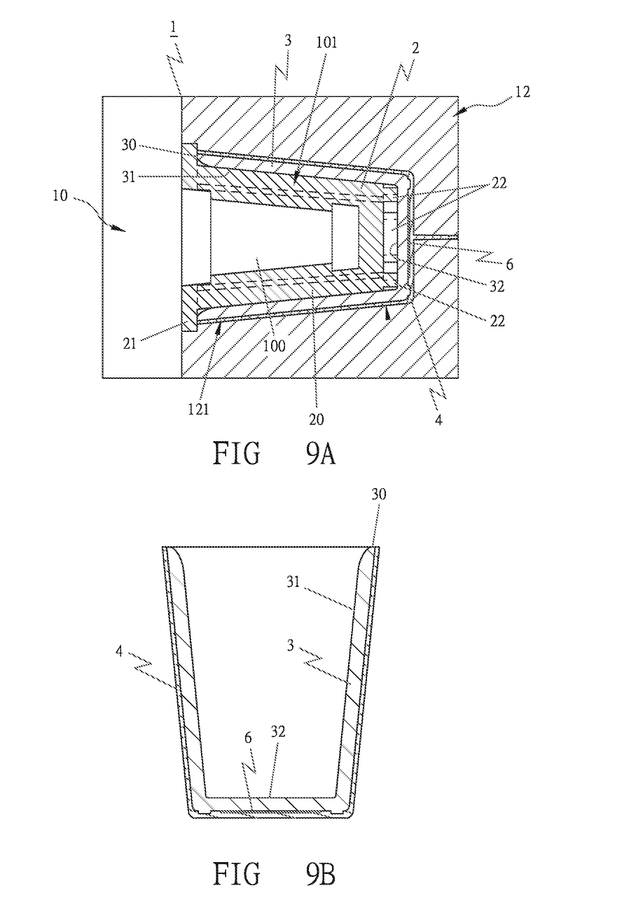

Referring to FIG. 8, to have a porcelain or glass product 3, a radio frequency identification chip (RFID) 6 and a plastic layer 4 formed integrally in a mold is first to have the radio frequency identification chip (RFID) 6 installed at a proper position of the porcelain or glass product 3 and then, the porcelain or glass product 3 is fitted on the soft mold sleeve 2 of the male mold 10. At this time, the front end 30, the inner wall 31 and the bottom side 32 of the porcelain or glass product 3 will respectively resist against the large annular surface 21, the circumferential surface 20 and the protruding members 22 of the soft mold sleeve 2, as shown in FIG. 9A, and the porcelain or glass product 3 can be fully fixed at the outer side of the male mold 10 and impossible to fall off by means of the elastic expansion characteristics of the soft mold sleeve 2. Thus, when the male mold 10 is received in the mold cavity 120 of the second female mold 12, a molding groove 121 will be formed between the second female mold 12 and the porcelain or glass product 3. At this time, the shaping machine is operated again to inject or extrude plastics into the molding groove 121 to form the plastic layer 4 on the whole or a part of the outer surface of the porcelain or glass product 3 to finish having a porcelain or glass product 3 formed integrally with a radio frequency identification chip (RFID) 6 and a plastic layer 4 in a mold.

The structure of a product made via the manufacturing method in the second preferred embodiment, as shown in FIG. 9B, is to have the whole or a part of the outer surface of the porcelain or glass product 3 provided with the plastic layer 4 made from various kinds of suitable plastic materials. The plastic layer 4 is most ideal to be made from foamed plastics for forming proper soft and hard elasticity to serve as a protective layer, a heat-insulating layer, a heat-preserving layer or a holding layer of the porcelain or glass product 3, and the radio frequency identification chip (RFID) 6 is disposed at a proper location of the porcelain or glass product 3. Thus, the porcelain or glass product 3, the radio frequency identification chip (RFID) 6 and the plastic layer 4 are formed integrally in a mold.

A third preferred embodiment of a manufacturing method structure of having a porcelain or glass product formed integrally with a label in a mold in the present invention, as shown in FIG. 10 is derived from and has technical correlation with the first preferred embodiment. The third preferred embodiment of this invention has a shaping mold 1 consisting of a male mold 10, a first female mold 11 and a second female mold 12. After the first female mold 11 is combined with the male mold 10, a shaping machine is first operated to inject or extrude plastics to cover a predetermined range of the male mold 10, which can be the whole or a part of the outer surface of the male mold 10, or an annular side or a bottom side of the male mold 10 and thus, a soft mold sleeve 2 can be provided at the predetermined range of the male mold 10. Next, a porcelain or glass product 3 shaped in advance is fitted around the outer side of the soft mold sleeve 2 of the male mold 10 and then, a label 5 is laid in the mold cavity 120 of the second female mold 12. Afterward, the second female mold 12 is combined with the male mold 10, and a plastic injection shaping machine or a plastic extrusion shaping machine is operated to inject or extrude plastics into a molding groove formed between the second female mold 12 and the male mold 10 to have the whole or a part of the outer surface of the porcelain or glass product 3 formed with a plastic layer 4 and have the whole or a part of the outer surface of the plastic layer 4 fixed with a label, thus finishing having a label formed integrally with a porcelain or glass product in a mold.

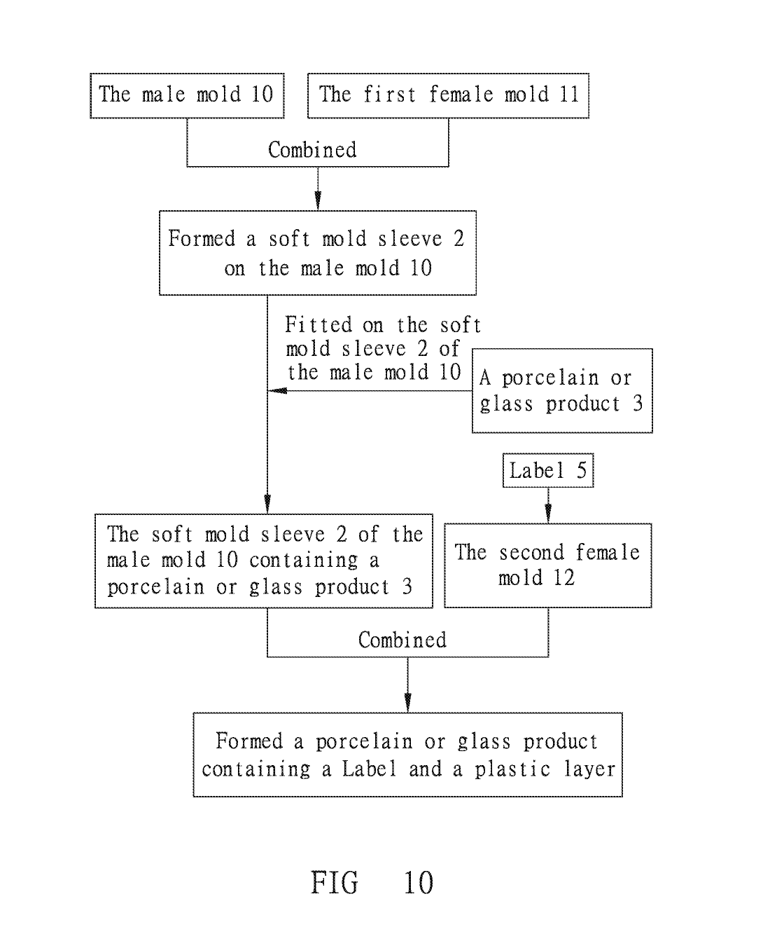

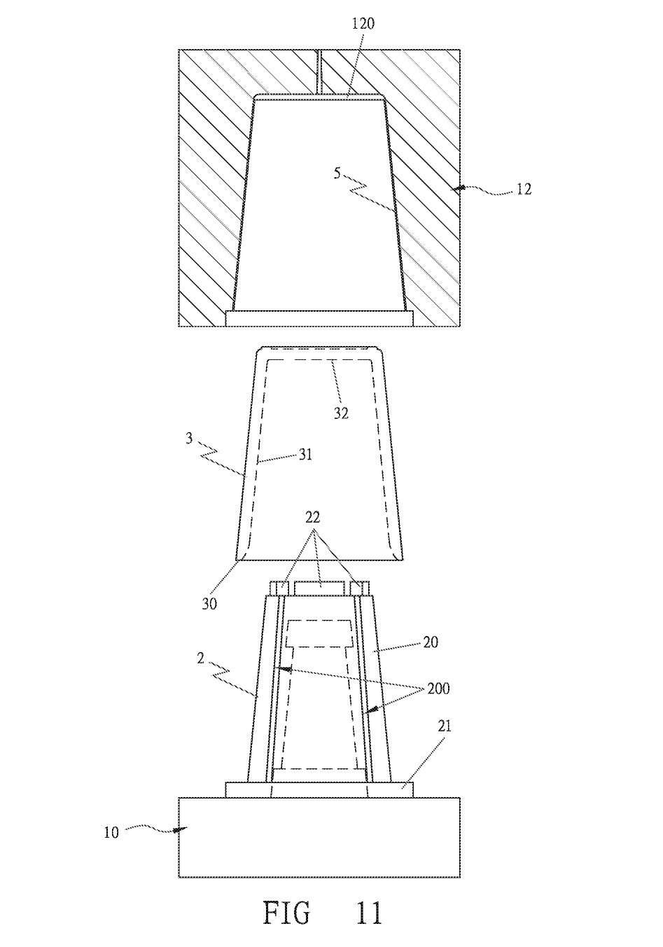

Referring to FIG. 11, when a porcelain or glass product 3, a plastic layer 4 and a label 5 are to be formed integrally in a mold, it is necessary to have the porcelain or glass product 3 fitted on the soft mold sleeve 2 of the male mold 10. At this time, the front end 30, the inner wall 31 and the bottom side 32 of the porcelain or glass product 3 will respectively resist the large annular surface 21, the circumferential surface 20 and the protruding members 22 of the soft mold sleeve 2, as shown in FIG. 12A and thus, the porcelain or glass product 3 can be completely secured at the outer side of the male mold 10 and impossible to fall off by the elastic expansion trait of the soft mold sleeve 2. Then, the label 5 is set in the mold cavity 120 of the second female mold 12 and the male mold 10 is combined with the mold cavity 120 of the second female mold 12 and thus, a molding groove 121 can be formed between the second female mold 12 and the porcelain or glass product 3. Meanwhile, plastics is injected or extruded into the molding groove 121 by the shaping machine to have the whole or a part of the outer surface of the porcelain or glass product 3 formed with the plastic layer 4 and then, a label 5 is stuck to the whole or a part of the outer surface of the plastic layer 4 to finish having a porcelain or glass product 5, a plastic layer 4 and a label 5 formed integrally in a mold.

The structure of the product made via the manufacturing method of the third preferred embodiment, as shown in FIG. 12B, is to have the whole or a part of the outer surface of the porcelain or glass product 5 formed with the plastic layer 4 made from various kinds of suitable plastic materials, and the plastic layer 4 has the whole or a part of the outer surface provided with the label 5, which can be plane or tri-dimensional, or the surface of the label can be printed thereon with patterns or characters.

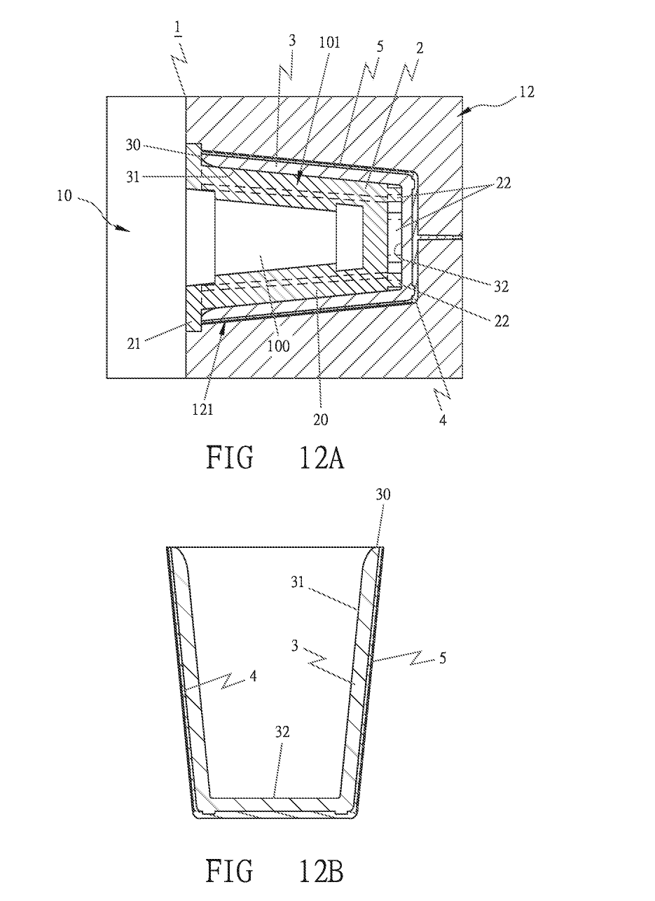

A fourth preferred embodiment of a manufacturing method and structure of having a porcelain or glass product formed integrally with a label in a mold in the present invention, as shown in FIG. 13, is derived from the manufacturing methods of the preferred embodiments 1-3 and has technical correlation with them. The fourth preferred embodiment of this invention includes a shaping mold 1 consisting of a male mold 10, a first female mold 11 and a second female mold 12. After the first female mold 11 is combined with the male mold 10, plastics is injected or extruded by a shaping machine to cover a predetermined range of the male mold 10, and foresaid predetermined range can be the whole or a part of the outer surface of the male mold 10, or located at an annular side or a bottom side of the male mold 10 and thus, a soft mold sleeve 2 can be formed at the predetermined range of the male mold 10. Subsequently, a porcelain or glass product 3 shaped beforehand is attached with a radio frequency identification chip (RFID) 6 at a proper location and then the porcelain or glass product 3 is fitted on the outer side of the soft mold sleeve 2 of the male mold 10, and a label 5 is deposited in the mold cavity 120 of the second female mold 12. Afterward, the second female mold 12 and the male mold 10 are combined together, and plastics is injected or extruded into a molding groove formed between the second female mold 12 and the male mold 10 by a plastic injection shaping machine or a plastic extrusion shaping machine. Thus, a plastic layer 4 can be formed at the whole or a part of the outer surface of the porcelain or glass product 3, the radio frequency identification chip (RFID) 6 can be provided between the porcelain or glass product 3 and the plastic layer 4, and the label 5 can be stuck to the whole or a part of the outer surface of the plastic layer 4 to finish having the porcelain or the glass product 3, the radio frequency identification chip (RFID) 6, the plastic layer 4 and the label 5 formed integrally in a mold.

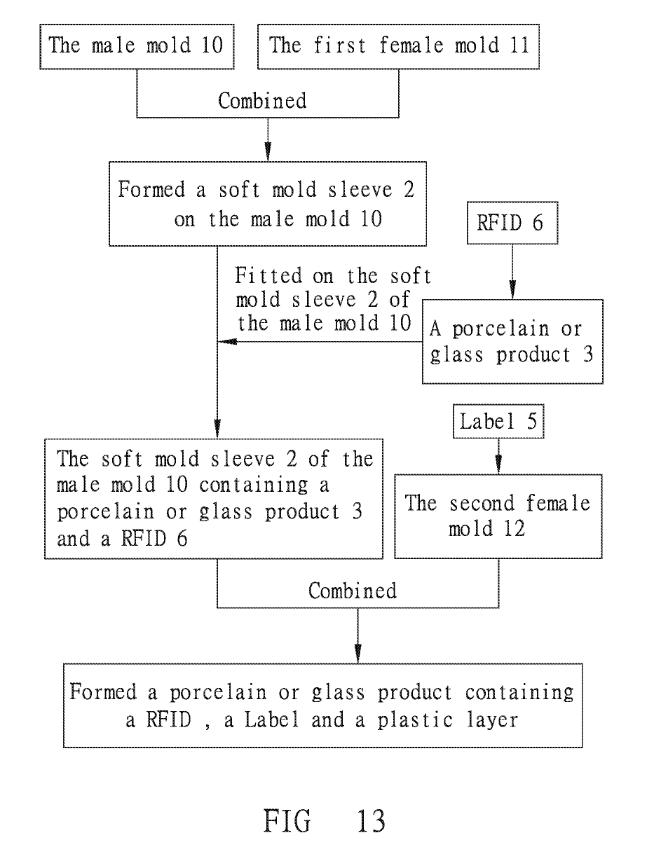

Referring to FIG. 14, when a porcelain or glass product 3, a radio frequency identification chip (RFUD) 6, a plastic layer 4 and a label 5 are to be integrally formed in a mold, it is necessary to have the radio frequency identification chip (RFID) 6 first installed at a proper location of the porcelain or glass product 3 and then, the porcelain or glass product 3 is fitted around the soft mold sleeve 2 of the male mold 10. At this time, the porcelain or glass product 3 will have a front end 30, an inner wall 31 and a bottom side 32 respectively resisting against the large annular surface 21, the circumferential surface 20 and the protruding member 22 of the soft mold sleeve 2, as shown in FIG. 15A, and further by the elastic expansion characteristics of the soft mold sleeve 2, the porcelain or glass product 3 can be completely fixed at the outer side of the male mold 10 not to fall off, and then the label 5 is set in the mold cavity 120 of the second female mold 12. After the male mold 10 is received in the mold cavity 120 of the second female mold 12, the molding groove 121 will be formed between the second female mold 12 and the porcelain or glass product 3 and meanwhile, plastics is injected or extruded into the molding groove 121 to have the whole or a part of the outer surface of the porcelain or glass product 3 provided with the plastic layer 4, and then have the whole or a part of the outer surface of the plastic layer 4 stuck with the label 5, thus finishing having a porcelain or glass product 3, a radio frequency identification chip (RFID) 6, a plastic layer 4 and a label 5 formed integrally in a mold.

The structure of the product made by the manufacturing method of the fourth preferred embodiment, as shown in FIG. 15B, is to have the whole or a part of the outer surface of the porcelain or glass product 3 provided with the plastic layer 4 that can be made from various kinds of suitable plastic materials, and the radio frequency identification chip (RFUD) 6 is positioned between the porcelain or glass product 3 and the plastic layer 4 for offering a certain source and authentication or identification. Then, the plastic layer 4 has the whole or a part of the outer surface provided with the label 5, which can be plane or tri-dimensional, or the label 5 can be printed with predetermined patterns or characters on the surface.

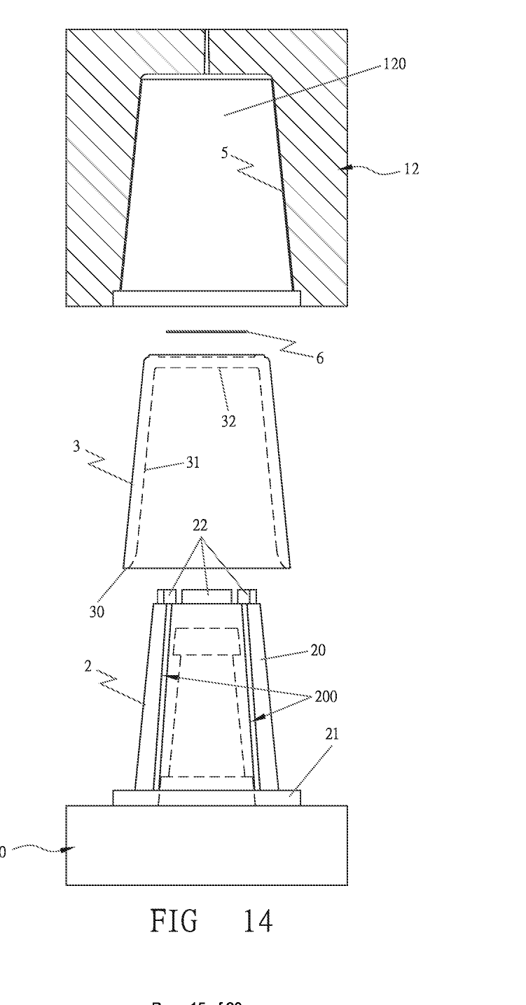

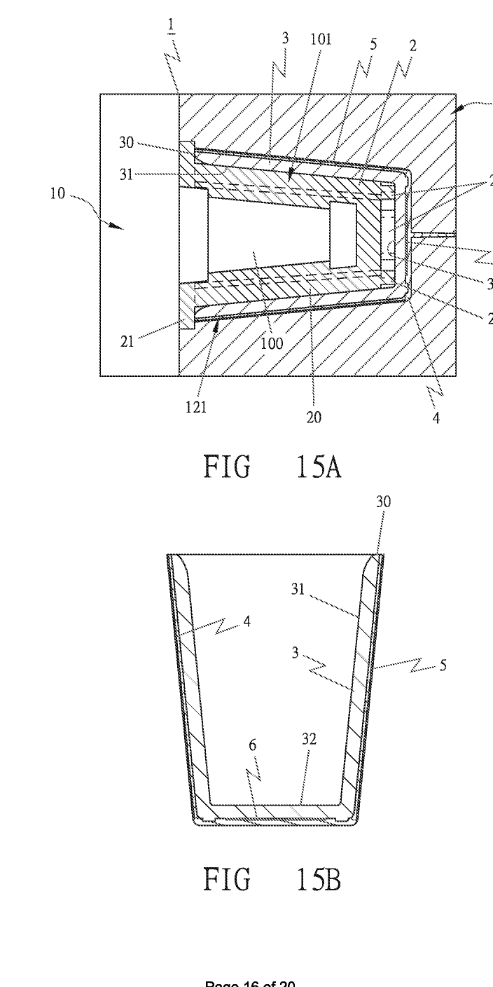

A fifth preferred embodiment of a manufacturing method and structure of having a porcelain or glass product formed integrally with a label in a mold in the present invention, as shown in FIG. 16A, is applicable to foresaid preferred embodiments 1-4. The fifth preferred embodiment of this invention is to have a porcelain or glass product provided with a stop ring 7 at a proper location of the outer wall adjacent to a front end for matching various porcelain or glass products 3 with special shapes. The stop ring 7 is made of soft material and able to resist a range of a porcelain or glass product 3 to be covered by plastics injected or extruded by a shaping machine, thus finishing having a label 5 formed integrally with a porcelain or glass product 3 with the stop ring 7 in a mold.

The structure of the product made via the manufacturing method of the fifth preferred embodiment is to have the outer wall 33 near the front end 30 of the porcelain or glass product 3 provided with the stop ring 7 having one end connected with the plastic layer 4 to form a structure of the porcelain or glass product 3 and the plastic layer 4, or form a structure of the porcelain or glass product 3 and the radio frequency identification chip 6 and a plastic layer 4 by having a radio frequency identification chip 6 installed between the porcelain or glass product 3 and the plastic layer 4. Further, the label 5 can be struck to the whole or a part of the outer surface of the plastic layer 4 to form a structure of the porcelain or glass product 3 and the plastic layer 4 and the label 5, or the radio frequency identification chip 6 can be set between the porcelain or glass product 3 and the plastic layer 4, and label 5 is stuck to the whole or a part of the outer surface of the plastic layer 4 to form a structure of the porcelain or glass product 3 combined with the radio frequency identification chip 6 and the plastic layer 4 and the label 5.

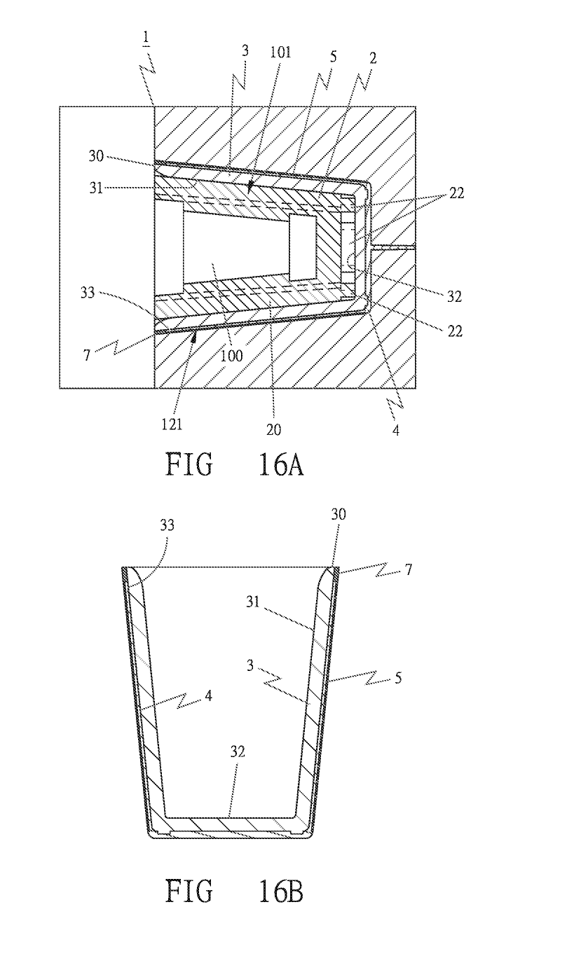

A sixth preferred embodiment of a manufacturing method and structure of having a porcelain or glass product formed integrally with a label in a mold in the present invention, as shown in FIG. 17A, is applicable to foresaid preferred embodiments 1-4. In the sixth preferred embodiment of this invention, the soft mold sleeve 2 is provided with no protruding member in accordance with the outer looks of a porcelain or glass product and referring to FIG. 17B, a structure of a porcelain or glass product 3 and a plastic layer 4, or a structure of a porcelain or glass product and a radio frequency identification chip 6 and a plastic layer 4, or a structure of a porcelain or glass product 3 and a plastic layer 4 and a label 5 or a structure of a porcelain or glass product 3 and a radio frequency identification chip 6 and a plastic layer 4 and a label 5 can also be manufactured.

A seventh preferred embodiment of a manufacturing method and structure of having a porcelain or glass product formed integrally with a label in a mold in the present invention, as shown in FIG. 18, can be applied to foresaid preferred embodiments 1-6. The seventh preferred embodiment is to have a male mold and a first female mold exchanged in role and function. After the first female mold 11a is combined with the male mold 10, referring to FIGS. 2-4, plastics can be injected or extruded in a molding groove 101 formed between the male mold 10 and the first female mold 11a by means of a plastic injection shaping machine or a plastic extrusion shaping machine. After the first female mold 11a is separated from the male mold 10, a soft mold sleeve 2a can be disposed at a predetermined range of the mold cavity 110a of the first female mold 11a and as previously stated, the soft mold sleeve 2a can be employed repeatedly or replaced. The soft mold sleeve 2a is formed with an accommodating space 23 matching with the shape of a porcelain or glass product 3 for receiving the porcelain or glass product 3 therein.

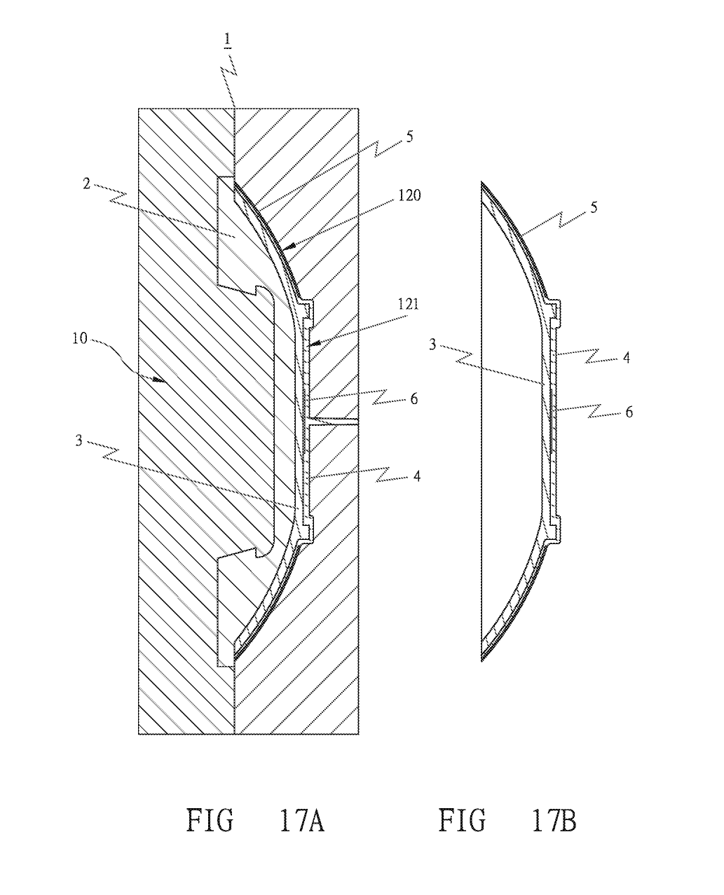

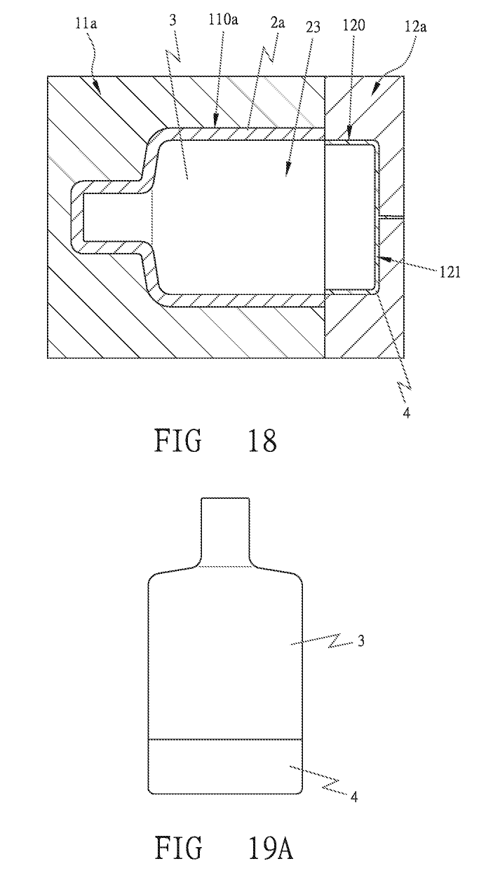

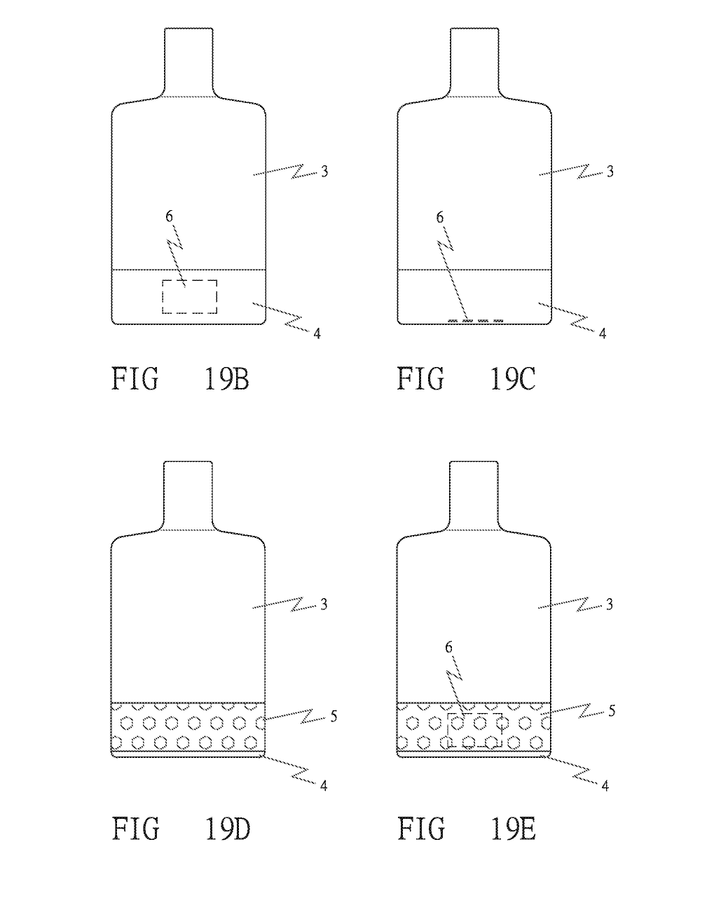

The structure of the product produced by the manufacturing method of the seventh preferred embodiment, as shown in FIGS. 19A-19E, is to have a part range of a porcelain or glass product 3 first positioned in the space 23 of the soft mold sleeve 2a of the first female mold 11a when the porcelain or glass product 3 is to be formed integrally with a label 5. At this time, the soft mold sleeve 2a will be properly covered on a partial surface of the porcelain or glass product 3 to enable the porcelain or glass product 3 to be fully fixed in the interior of the first female mold 11a not to fall off via the elastic expansion peculiarity of the soft mold sleeve 2a, and a partial range of the porcelain or glass product 3 serves as an effect of the male mold 10. After a second female mold 12a is combined with the first female mold 11a, a molding groove 121 will be formed between the second female mold 12a and a partial range of the porcelain or glass product 3 and at this time, plastics can be injected or extruded into the molding groove 121 to have the whole or a part of the outer surface of the porcelain or glass product 3 provided with a plastic layer 4 for producing a structure of the porcelain or glass product 3 formed integrally with the plastic layer 4, as shown in FIG. 19A. In addition, a radio frequency identification chip 6 can be installed at one side of the porcelain or glass product 3, as shown in FIG. 19B, or fixed at a bottom side of the porcelain or glass product 3, as shown in FIG. 19C, to manufacture a structure of the porcelain or glass product 3 formed integrally with the radio frequency identification chip 6 and the plastic layer 4, or a structure of the porcelain or lass product 3 formed integrally with the radio frequency identification chip 6, the plastic layer 4 and the label 5, as shown in FIG. 19D, or a structure of the porcelain or glass product 3 formed integrally with the radio frequency identification chip 6, the plastic layer 4 and the label 5, as shown in FIG. 19E.

To sum up, the manufacturing method and structure of having a label formed integrally with a porcelain or glass product in a mold can completely solving the problem of having a porcelain or glass product formed integrally with a label. If a porcelain or glass product is used as a container to be filled therein with food or drink, it is most preferable that such containers are impossible to be recycled after they are used once. In this case, fakers must take great pains to have used porcelain or glass products combined with counterfeited labels, able to insure safety of food and drink.

While the preferred embodiments of the invention have been described above, it will be recognized and understood that various modifications may be made therein and the appended claims are intended to cover all such modifications that may fall within the spirit and scope of the invention.

1. A manufacturing method of having a porcelain or glass product formed integrally with a label in a mold comprising a shaping mold, said shaping mold consisting of a male mold, a first female mold and a second female mold, plastics injected or extruded by a shaping machine to cover a predetermined range of said male mold after said first female mold is combined with said male mold, said male mold having an outer surface formed with a soft mold sleeve, a porcelain or glass product shaped in advance fitted on an outer side of said soft mold sleeve outside said male mold, said second female mold combined with said male mold to form a molding groove between said second female mold and said male mold, plastics injected or extruded into said molding groove by a shaping machine, said porcelain or glass product having the whole or a part of an outer surface provided with a plastic layer to finish having said porcelain or glass product and said plastic layer formed integrally in a mold.

2. The manufacturing method of having a porcelain or glass product formed integrally with a label in a mold as claimed in claim 1, wherein said soft mold sleeve is formed with a circumferential surface, said circumferential surface provided with recesses for preventing said soft mold sleeve being closely stuck to an inner wall of said porcelain or glass product to enable said porcelain or glass product to be removed from said soft mold sleeve, said circumferential surface having one side disposed with a large annular surface for said porcelain or glass product to resist thereon to restrict combination of said porcelain or glass product, said circumferential surface having another side provided with protruding members, said protruding members able to produce a proper compression effect when said protruding members are pressed so as to prevent said porcelain or glass product from being pressed and broken.

3. The manufacturing method of having a porcelain or glass product formed integrally with a label in a mold as claimed in claim 2, wherein said protruding member(s) is signal or plural.

4. The manufacturing method of having a porcelain or glass product formed integrally with a label in a mold as claimed in claim 2, wherein said protruding member is of an annular shape or of a wavy annular shape.

5. A manufacturing method of having a porcelain or glass product formed integrally with a label in a mold comprising a shaping mold, said shaping mold consisting of a male mold, a first female mold and a second female mold, plastics injected or extruded to cover a predetermined range of said male mold by a shaping machine after said first female mold is combined with said male mold, said male mold having an outer surface formed with a soft mold sleeve, a porcelain or glass product shaped in advance installed with a radio frequency identification chip, said porcelain or glass product with said radio frequency identification chip fitted on said soft mold sleeve of said male mold, said second female mold combined with said male mold to form a molding groove, plastics injected or extruded by a shaping machine to get into said molding groove formed between said second female mold and said male mold, a plastic layer provided at the whole or a part of the outer surface of said porcelain or glass product, and a radio frequency identification chip set between said porcelain or glass product and said plastic layer to finish having said porcelain or glass product and said radio frequency identification chip and said plastic layer formed integrally in a mold.

6. The manufacturing method of having a porcelain or glass product formed integrally with a label in a mold as claimed in claim 5, wherein said soft mold sleeve is formed with a circumferential surface provided on surface with recesses for preventing said soft mold sleeve from being closely stuck to an inner wall of said porcelain or glass product to enable said porcelain or glass product to be removed easily from said soft mold sleeve, said circumferential surface having one side disposed with a large annular surface for resisting said porcelain or glass product and restricting combination of said porcelain or glass product with said soft mold sleeve, said circumferential surface having another side provided with protruding members, said protruding members able to produce a proper compression effect when said protruding members are pressed for preventing said porcelain or glass product from being broken.

7. The manufacturing method of having a porcelain or glass product formed integrally with a label in a mold as claimed in claim 6, wherein said protruding member is single or plural.

8. The manufacturing method of having a porcelain or glass product formed integrally with a label in a mold as claimed in claim 6, wherein said protruding member is of an annular shape or of a wavy annular shape.

9. The manufacturing method of having a porcelain or glass product formed integrally with a label in a mold as claimed in claim 1, wherein said soft mold sleeve is provided at the whole or a part of a predetermined range of said male mold.

10. The manufacturing method of having a porcelain or glass product formed integrally with a label in a mold as claimed in claim 1, wherein said soft mold sleeve is disposed at an annular side or a bottom side of said male mold.

11. The manufacturing method of having a porcelain or glass product formed integrally with a label in a mold as claimed in claim 1, wherein said male mold is formed with a recessed circumference for said soft mold sleeve to be closely stuck thereon and not easy to fall off.

12. The manufacturing method of having a porcelain or glass product formed integrally with a label in a mold as claimed in claim 1, wherein said soft mold sleeve is provided with a circumference surface formed thereon with recesses for preventing said soft mold sleeve from being closely stuck to the inner wall of said porcelain or glass product to enable said porcelain or glass product to be removed easily from said soft mold sleeve, said circumference surface having one side formed with a large annular surface for resisting said porcelain or glass product and confining combination of said porcelain or glass product with said soft mold sleeve.

13. The manufacturing method of having a porcelain or glass product formed integrally with a label in a mold as claimed in claim 1, wherein said soft mold sleeve has elastic expansion characteristics so that said porcelain or glass product can be fully fixed at an outer side of said male mold sleeve and impossible to fall off.

14. The manufacturing method of having a porcelain or glass product formed integrally with a label in a mold comprising a shaping mold, said shaping mold consisting of a male mold, a first female mold and a second female mold, plastics injected or extruded by a shaping machine to cover a predetermined range of said male mold and form a soft mold sleeve at an outer surface of said male mold after said first female mold is combined with said male mold, a porcelain or glass product shaped beforehand fitted on an outer side of said soft mold sleeve outside said male mold, a label set in a mold cavity of said second female mold and then said second female mold combined with said male mold, plastics injected or extruded into a molding groove formed between said second female mold and said male mold, said porcelain or glass product having the whole or a part of the outer surface provided with a plastic layer, and a label stuck to the whole or a part of the outer surface of said plastic layer, thus, finishing having said porcelain or glass product formed integrally with said label in a mold.

15. The manufacturing method of having a porcelain or glass product formed integrally with a label in a mold as claimed in claim 14, wherein said soft mold sleeve is formed with a circumferential surface having recesses provided thereon for preventing said mold sleeve from being closely attached to the inner wall of said porcelain or glass product to enable said porcelain or glass product to be removed easily from said soft mold sleeve, said circumferential surface having one side disposed with a large annular surface for resisting said porcelain or glass product and restricting combination of said porcelain or glass product with said soft mold sleeve, said circumferential surface having another side provided with protruding members, said protruding members able to produce a proper compression effect after said protruding members are pressed for preventing said porcelain or glass product from being pressed and broken.

16. The manufacturing method of having a porcelain or glass product formed integrally with a label in a mold as claimed in claim 15, wherein said protruding member is single or plural.

17. The manufacturing method of having a porcelain or glass product formed integrally with a label in a mold as claimed in claim 15, wherein said protruding member is of an annular shape or a wavy annular shape.

18. A manufacturing method of having a porcelain or glass product formed integrally with a label in a mold comprising a shaping mold, said shaping mold consisting of a male mold, a first female mold and a second female mold, plastics injected or extruded by a shaping machine to cover a predetermined range of said male mold to have an outer surface of said male mold forming a soft mold sleeve after said first female mold is combined with said male mold, said porcelain or glass product installed with a radio frequency identification chip and fitted around said soft mold sleeve at an outer side of said male mold, a label placed in a mold cavity of said second female mold and said second female mold combined with said male mold, plastics injected or extruded into a molding groove formed between said second female mold and said male mold by a shaping machine, said porcelain or glass product having the whole or a part of outer surface provided with a plastic layer, said radio frequency identification chip positioned between said porcelain or glass product and said plastic layer, said label stuck to the whole or a part of the outer surface of said plastic layer, thus finishing having a porcelain or glass product and a label formed integrally in a mold.

19. The manufacturing method of having a porcelain or glass product formed integrally with a label in a mold as claimed in claim 18, wherein said soft mold sleeve is formed with a circumferential surface provided thereon with recesses for preventing said soft mold sleeve from closely stuck to the inner wall of said porcelain or glass product so as to enable said porcelain or glass product to be removed easily from said soft mold sleeve, said circumferential surface having one side disposed with a large annular surface for said porcelain or glass product to resist thereon and for confining combination of said porcelain or glass product with said soft mold sleeve, said circumferential surface having another end provided with protruding members, said protruding members producing a proper compression effect after pressed to prevent said porcelain or glass product from being broken.

20. The manufacturing method of having a porcelain or glass product formed integrally with a label in a mold as claimed in claim 19, wherein said protruding member is single or plural.

21. The manufacturing method of having a porcelain or glass product formed integrally with a label in a mold as claimed in claim 19, wherein said protruding member is formed into an annular shape or a wavy annular shape.

22. The manufacturing method of having a porcelain or glass product formed integrally with a label in a mold as claimed in claim 14, wherein said soft mold sleeve is mounted at the whole or a part of a predetermined range of said male mold.

23. The manufacturing method of having a porcelain or glass product formed integrally with a label in a mold as claimed in claim 14, wherein said soft mold sleeve is disposed at an annular side or at a bottom side of said male mold.

24. The manufacturing method of having a porcelain or glass product formed integrally with a label in a mold as claimed in claim 14, wherein said male mold is formed with a recessed circumference to be tightly combined with said soft mold sleeve to prevent said soft mold sleeve from falling off.

25. The manufacturing method of having a porcelain or glass product formed integrally with a label in a mold as claimed in claim 14, wherein said soft mold sleeve is formed with a circumferential surface disposed thereon with recesses for preventing said soft mold sleeve from closely contacting the inner wall of said porcelain or glass product for enabling said porcelain or glass product to be moved from said soft mold sleeve, said circumferential surface having one side formed with a large ring surface for said porcelain or glass product to resist thereon and for limiting combination of said porcelain or glass product with said soft mold sleeve.

26. The manufacturing method of having a porcelain or glass product formed integrally with a label in a mold as claimed in claim 14, wherein said soft mold sleeve has elastic expansion trait for enabling said porcelain or glass product to be completely fixed at an outer side of said male mold and impossible to fall off.

27. A manufacturing method of having a porcelain or glass product formed integrally with a label in a mold comprising a shaping mold, said shaping mold consisting of a first female mold, a male mold and a second female mold, after said first female mold and said male mold are combined together, plastics injected or extruded into a molding groove formed between said male mold and said first female mold by a shaping machine, a soft mold sleeve formed at a predetermined range of a mold cavity of said first female mold after said first female mold and said male mold are separated, said soft mold sleeve formed with an accommodating space for receiving therein a partial range of said porcelain or glass product, with said partial range of said porcelain or glass product acting as an effect of said male mold, a label laid in the mold cavity of said second female mold and then said second female mold combined with said first female mold, a molding groove formed between said second female mold and a partial range of said porcelain or glass product, plastics injected or extruded into said molding groove by a shaping machine to form a plastic layer at the whole or a part of the outer surface of said porcelain or glass product, said label stuck to the whole or a part of the outer surface of said plastic layer, thus finish having a porcelain or glass product formed integrally with a label in a mold.

28. The manufacturing method of having a porcelain or glass product formed integrally with a label in a mold as claimed in claim 27, wherein said soft mold sleeve is covered on a partial surface of said porcelain or glass product, and said porcelain or glass product can be fully fixed in an interior of said first female mold and impossible to fall off by elastic expansion characteristics of said soft mold sleeve.

29. A structure of having a porcelain or glass product formed integrally with a label in a mold at least comprising a porcelain or glass product, said porcelain or glass product having the whole or a part of outer surface provided with a plastic layer, said plastic layer serving as a protective layer, a heat-insulating layer, a heat-preserving layer or a holding layer.

30. A structure of having a porcelain or glass product formed integrally with a label in a mold at least comprising a porcelain or glass product, said porcelain or glass product having the whole or a part of outer surface provided with a plastic layer to serve as a protective layer, a heat-insulating layer or a grasping layer, a radio frequency identification chip installed between said porcelain or glass product and said plastic layer to offer a certain source authentication or identification.

31. The structure of having a porcelain or glass product formed integrally with a label in a mold as claimed in claim 29, wherein said plastic layer is made from various kinds of suitable plastic materials.

32. The structure of having a porcelain or glass product formed integrally with a label in a mold as claimed in claim 29, wherein said porcelain or glass product is provided with a stop ring at an outer wall adjacent to a front end, and said stop ring has one end connected with said plastic layer.

33. A structure of having a porcelain or glass product formed integrally with a label in a mold at least comprising a porcelain or glass product, said porcelain or glass product having the whole or a part of outer surface provided with a plastic layer to be used as a protective layer, a heat-insulating layer, a heat-preserving layer or a holding layer, said plastic layer having the whole or a part of outer surface set with a label.

34. A structure of having a porcelain or glass product formed integrally with a label in a mold at least comprising a porcelain or glass product, said porcelain or glass product having the whole or a part of outer surface formed with a plastic layer, said plastic layer serving as a protective layer, a heat-insulating layer, or a grasping layer, a radio frequency identification chip positioned between said porcelain or glass product and said plastic layer, a label attached on the whole or a part of the outer surface of said plastic layer.

35. The structure of having a porcelain or glass product formed integrally with a label in a mold as claimed in claim 33, wherein said plastic layer is made from various kinds of suitable plastic materials.

36. The structure of having a porcelain or glass product formed integrally with a label in a mold as claimed in claim 33, wherein said label is a plane label or a tri-dimensional label, or said label is printed on surface with predetermined patterns or characters.

37. The structure of having a porcelain or glass product formed integrally with a label in a mold as claimed in claim 33, wherein said plastic layer has the whole or a part of outer side provided with said label.

38. The structure of having a porcelain or glass product formed integrally with a label in a mold as claimed in claim 33, wherein said porcelain or glass product is provided with a stop ring at an outer wall near a front end and said stop ring has one end connected with said plastic layer.

39. The manufacturing method of having a porcelain or glass product formed integrally with a label in a mold as claimed in claim 5, wherein said soft mold sleeve is provided at the whole or a part of a predetermined range of said male mold.

40. The manufacturing method of having a porcelain or glass product formed integrally with a label in a mold as claimed in claim 5, wherein said soft mold sleeve is disposed at an annular side or a bottom side of said male mold.

41. The manufacturing method of having a porcelain or glass product formed integrally with a label in a mold as claimed in claim 5, wherein said male mold is formed with a recessed circumference for said soft mold sleeve to be closely stuck thereon and not easy to fall off.

42. The manufacturing method of having a porcelain or glass product formed integrally with a label in a mold as claimed in claim 5, wherein said soft mold sleeve is provided with a circumference surface formed thereon with recesses for preventing said soft mold sleeve from being closely stuck to the inner wall of said porcelain or glass product to enable said porcelain or glass product to be removed easily from said soft mold sleeve, said circumference surface having one side formed with a large annular surface for resisting said said porcelain or glass product and confining combination of said porcelain or glass product with said soft mold sleeve.

43. The manufacturing method of having a porcelain or glass product formed integrally with a label in a mold as claimed in claim 5, wherein said soft mold sleeve has elastic expansion characteristics so that said porcelain or glass product can be fully fixed at an outer side of said male mold sleeve and impossible to fall off.

44. The manufacturing method of having a porcelain or glass product formed integrally with a label in a mold as claimed in claim 18, wherein said soft mold sleeve is mounted at the whole or a part of a predetermined range of said male mold.

45. The manufacturing method of having a porcelain or glass product formed integrally with a label in a mold as claimed in claim 18, wherein said soft mold sleeve is disposed at an annular side or at a bottom side of said male mold.

46. The manufacturing method of having a porcelain or glass product formed integrally with a label in a mold as claimed in claim 18, wherein said male mold is formed with a recessed circumference to be tightly combined with said soft mold sleeve to prevent said soft mold sleeve from falling off.

47. The manufacturing method of having a porcelain or glass product formed integrally with a label in a mold as claimed in claim 18, wherein said soft mold sleeve is formed with a circumferential surface disposed thereon with recesses for preventing said soft mold sleeve from closely contacting the inner wall of said porcelain or glass product for enabling said porcelain or glass product to be moved from said soft mold sleeve, said circumferential surface having one side formed with a large ring surface for said porcelain or glass product to resist thereon and for limiting combination of said porcelain or glass product with said soft mold sleeve.

48. The manufacturing method of having a porcelain or glass product formed integrally with a label in a mold as claimed in claim 18, wherein said soft mold sleeve has elastic expansion trait for enabling said porcelain or glass product to be completely fixed at an outer side of said male mold and impossible to fall off.

49. The structure of having a porcelain or glass product formed integrally with a label in a mold as claimed in claim 30, wherein said plastic layer is made from various kinds of suitable plastic materials.

50. The structure of having a porcelain or glass product formed integrally with a label in a mold as claimed in claim 30, wherein said porcelain or glass product is provided with a stop ring at an outer wall adjacent to a front end, and said stop ring has one end connected with said plastic layer.

51. The structure of having a porcelain or glass product formed integrally with a label in a mold as claimed in claim 34, wherein said plastic layer is made from various kinds of suitable plastic materials.

52. The structure of having a porcelain or glass product formed integrally with a label in a mold as claimed in claim 34, wherein said label is a plane label or a tri-dimensional label, or said label is printed on surface with predetermined patterns or characters.

53. The structure of having a porcelain or glass product formed integrally with a label in a mold as claimed in claim 34, wherein said plastic layer has the whole or a part of outer side provided with said label.

54. The structure of having a porcelain or glass product formed integrally with a label in a mold as claimed in claim 34, wherein said porcelain or glass product is provided with a stop ring at an outer wall near a front end and said stop ring has one end connected with said plastic layer.
